(19) United States
(12) Patent Application Publication
(10) Pub. No.: US 2024/0386815 A1
(43) Pub. Date: Nov. 21, 2024

(54) Car Window Vehicle Sticker Placard Device

(71) Applicants: Marcus Alderson, Homewood, IL (US); Michael Fight, Matteson, IL (US)

(72) Inventors: Marcus Alderson, Homewood, IL (US); Michael Fight, Matteson, IL (US)

(21) Appl. No.: 18/645,881

(22) Filed: Apr. 25, 2024

Related U.S. Application Data
(60) Provisional application No. 63/502,949, filed on May 18, 2023.

(51) Int. Cl. G09F 3/20

(52) U.S. Cl. CPC G09F 3/203

(57) ABSTRACT

A vehicle sticker placard device is disclosed that is an expanded placard for a vehicle. The vehicle sticker placard device comprises a body component that is configured in a rectangular shape with several individual compartments to house city, state, toll, parking, and other stickers or identification cards. Each compartment is covered with a thin plastic sheet to create a pocket for displaying the cards or stickers. Each pocket comprises an open top, to allow users to easily interchange stickers/cards, as needed. The body component is removable and secures to a vehicle window with adhesive. Thus, users can place the device on their vehicle windshield and display appropriate stickers with ease.

### CROSS-REFERENCE TO RELATED APPLICATION

The present application claims priority to, and the benefit of, U.S. Provisional Application No. 63/502,949, which was filed on May 18, 2023, and is incorporated herein by reference in its entirety.

### FIELD OF THE INVENTION

The present invention relates generally to the field of vehicle sticker placard devices. More specifically, the present invention relates to a convenient placard system for supporting vehicle identification stickers and cards. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in vehicle sticker placard devices. Generally, people who own or lease vehicles may have several identification cards or stickers required to operate the vehicle. Inspection and emission stickers may be placed on a windshield, however, if the windshield is damaged, removing these stickers can be difficult. Further, people may have several placards to accommodate handicapped cards, parking stickers, and the like. However, finding spots to place these items can be difficult without impeding the driver's vision.

It is common for federal, state, municipal, and local governments, as well as clubs, residential associations, private beaches, parking lots, schools, businesses, or other organizations, to require the display of certain decals, stickers, labels, placards, or similar items in the windows of motor vehicles, particularly automobiles, to indicate the particular automobile owner or operator's compliance with registration, inspection, residency, membership, affiliation, enrollment, or other obligations, or to otherwise indicate the particular status of the motor vehicle or the owner or operator thereof pertinent to the particular authority or organization. Present means and methods of displaying these decals, stickers, labels, placards, or similar items, provide that the decals, stickers, labels, placards, or similar items be affixed or placed directly on the interior or exterior surface of the windshield glass, or the glass of certain other windows of the motor vehicle, or to the forward-facing portion of the rearview mirror.

However, affixing the decals, stickers, labels, placards, or similar items, creates a reduced field of vision through the vehicle windows. Additionally, as time passes and replacement decals are issued, it becomes necessary to remove and/or replace the decals, stickers, labels, placards, or similar items affixed to the windows. At times this may be very difficult due to the awkward positioning of the decals, stickers, labels, placards, or similar items, as well as to the condition of the adhesive which affixed the decal. Typically, adhesive-coated registration stickers, affixed to the windshield of a motor vehicle, cannot be removed without either mutilating or destroying the sticker.

Accordingly, there is a demand for an improved vehicle sticker placard device that eliminates the need for users to scrape off old stickers from their windshield. More particularly, there is a demand for a vehicle sticker placard device that supports multiple stickers and configurations.

Therefore, there exists a long-felt need in the art for a vehicle sticker placard device that provides users with a convenient placard system for supporting vehicle identification stickers and cards. There is also a long-felt need in the art for a vehicle sticker placard device that allows users to place the placard on a windshield in a horizontal or vertical configuration via an adhesive, keeping the placard visible at all times. Further, there is a long-felt need in the art for a vehicle sticker placard device that includes multiple spaces to store inspection stickers, toll cards, parking cards or stickers, etc. Moreover, there is a long-felt need in the art for a device that eliminates the need to scrape the window with a blade to remove stickers if a windshield replacement is required. Further, there is a long-felt need in the art for a vehicle sticker placard device that is manufactured of plastic. Finally, there is a long-felt need in the art for a vehicle sticker placard device that allows users to insert and remove vehicle stickers and cards with ease.

The subject matter disclosed and claimed herein, in one embodiment thereof, comprises a vehicle sticker placard device. The device is an expanded placard for a vehicle. The vehicle sticker placard device comprises a body component that is configured in a rectangular shape with several individual compartments to house city, state, toll, parking, and other stickers or identification cards. Each compartment is covered with a thin plastic sheet to create a pocket for displaying the cards or stickers. Each pocket comprises an open top, to allow users to easily interchange stickers/cards, as needed. The body component is removable and secures to a vehicle window with adhesive. Thus, users can place the device on their vehicle windshield and display appropriate stickers with ease.

In this manner, the vehicle sticker placard device of the present invention accomplishes all of the foregoing objectives and provides users with a device that displays vehicle stickers and cards. The device is a transparent, plastic structure that comprises multiple compartments for displaying the cards/stickers. The device can be manufactured of a plastic material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle sticker placard device. The device is an expanded placard for a vehicle. The vehicle sticker placard device comprises a body component that is configured in a rectangular shape with several individual compartments to house city, state, toll, parking, and other stickers or identification cards. Each compartment is covered with a thin plastic sheet to create a pocket for displaying the cards or stickers. Each pocket comprises an open top, to allow users to easily interchange stickers/cards, as needed. The body component is removable and secures to a vehicle window with adhesive. Thus, users can place the device on their vehicle windshield and display appropriate stickers with ease.

In one embodiment, the vehicle sticker placard device contemplates a vehicle registration sticker, inspection sticker, certificate, license, parking sticker, and/or photograph display holder, etc., into which the stickers, certificates, licenses, cards, and/or photographs may be inserted. Further, the vehicle sticker placard device is used to removably display a number of different stickers, certificates, registration stickers, inspection stickers, parking stickers, certificates, licenses, and/or photographs, etc., at one time.

In one embodiment, the vehicle sticker placard device comprises a body component of minimal thickness and an elongated rectangular configuration, with top and bottom elongated edges extending generally parallel along the length thereof and with opposite end edges extending transverse to the length thereof. The body component also comprises a front surface that faces out the vehicle windshield and a rear surface that faces the interior of the vehicle. Further, the body component comprises a semi-rigid flat sheet of plastic material having multiple individual compartments to display a registration sticker, inspection sticker, certificate, license, and/or photograph, etc.

In one embodiment, the body component comprises an adhesive coating layer made of an impermanent adhesive material affixed to a front surface of the body component, which allows the body component to be repeatedly attached to one surface, removed, and attached to another surface without damaging the body component or the surface to which the body component is attached. The use of an impermanent adhesive allows the user to use the body component in multiple locations over a period of time. Further, because an impermanent adhesive will not damage the surface to which it is mounted, a user is provided with significant flexibility as to the types of surfaces to which the body component may be attached. Typically, the body component is secured to an interior of the vehicle windshield.

Furthermore, the adhesive coating layer is made of a flexible material, such that the body component can be releasably secured to the interior of the vehicle window. The adhesive layer may be approximately ⅛ inch thick and it is coated with a pressure sensitive adhesive. For packing and shipping, the adhesive layer may be protected by a conventional peel-off covering. The peel-off covering is peeled off and discarded to expose the adhesive layer, in order to adhere the device to a supporting surface. Further, the adhesive coating layer is an optically clear layer that is manufactured of transparent material to easily display the vehicle stickers and cards.

In one embodiment, the body component comprises a plurality of pockets in which a removable vehicle registration card or sticker is adapted to be slidably received and displayed. Specifically, the individual compartments each comprise a pocket and each of the pockets act as a clear plastic protective sheath for displaying the vehicle cards/stickers. The pockets allow the vehicle cards/stickers to be prominently displayed on one side and seen through the vehicle window. Specifically, each compartment is covered with a thin plastic sheet sealed at its perimeter edges and left open at the top, to create a pocket for displaying the cards or stickers. Each pocket comprises a sealed bottom seam, sealed opposing right and left seams, and an open top creating an open interior. The open top allows users access to the open interior and allows users to easily interchange stickers/cards, as needed within the pockets. Further, the front surface of the pockets are optically clear for viewing the inserted vehicle stickers or cards from one or both sides thereof.

In one embodiment, the body component can comprise any suitable number of pockets. Further, the device can be manufactured in different sizes, with a different number of pockets, depending on the needs and/or wants of a user. The pockets can be any suitable size and shape as is known in the art, as long as they act to retain a vehicle sticker or card. Further, the body component can comprise pockets of varying size and width, depending on the needs and/or wants of a user.

In one embodiment, the body component is made of a light plastic but durable material to protect the vehicle stickers and cards. Further, the body component is manufactured of transparent material to easily display the vehicle stickers and cards. In one embodiment, the front and rear surfaces of the body component are optically clear, thereby adapting the body component for placement on the interior or exterior of a transparent window, such as the interior or exterior of a glass automobile window, for viewing the inserted vehicle stickers or cards from one or both sides thereof. Preferably, for maximum adaptability, the compartments and pockets, as well as the adhesive layer, are all manufactured of optically clear material. Further, the device is transparent, so as not to interfere with a driver's view from the passenger compartment.

In one embodiment, the vehicle sticker placard device can be configured in a horizontal or vertical configuration, depending on the needs and/or wants of a user. Specifically, the individual compartments of the body component can be arranged horizontally, in a linear line with the plurality of pockets positioned side-by-side. In another embodiment, the individual compartments of the body component can be arranged vertically, such that the plurality of pockets are positioned in a linear line with pockets positioned above and below each other. Specifically, the plurality of pockets are positioned, such that the bottom of each pocket contacts a top of the pocket below it. The horizontal and vertical configurations allow the users to display the vehicles stickers and/or cards within the body component at particular locations on the interior of the vehicle windshield, as prescribed by the pertinent authorities, or issuers of the decals, stickers, or cards, as the case may be.

In use, the protective covering is peeled off the adhesive coating layer, and the body component is pressed against the inside face of the car windshield. By virtue of the flexibility in the body component and the flexible adhesive coating layer, the body component will readily accommodate itself to any curvature in the windshield. When the driver is in the vehicle, he will insert various vehicle registration cards and/or stickers, which he/she may carry in his/her wallet, into the pockets of the body component where they will be prominently displayed. Whenever the user leaves the vehicle, he/she can remove the vehicle cards and/or stickers and return them to his/her wallet, if needed, otherwise the vehicle cards and/or stickers can remain in the pockets of the body component of the device.

In yet another embodiment, the vehicle sticker placard device comprises a plurality of indicia.

In yet another embodiment, a method of displaying multiple vehicle stickers and cards on a vehicle windshield is disclosed. The method includes the steps of providing a vehicle sticker placard device comprising a body component with multiple pockets for displaying vehicle stickers and cards. The method also comprises inserting vehicle stickers and cards into the pockets to be displayed. Further, the method comprises securing the body component via adhesive to the interior of a vehicle windshield. Finally, the method comprises interchanging the vehicle stickers and cards, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the vehicle sticker placard device of the present invention in accordance with the disclosed architecture;

FIG. 2 illustrates a perspective view of one embodiment of the vehicle sticker placard device of the present invention showing how stickers are inserted in a horizontal configuration in accordance with the disclosed architecture;

FIG. 3 illustrates a perspective view of one embodiment of the vehicle sticker placard device of the present invention showing how stickers are inserted in a vertical configuration in accordance with the disclosed architecture;

FIG. 4 illustrates a perspective view of one embodiment of the vehicle sticker placard device of the present invention showing the horizontal configuration applied to a windshield in accordance with the disclosed architecture;

FIG. 5 illustrates a perspective view of one embodiment of the vehicle sticker placard device of the present invention showing the vertical configuration applied to a windshield in accordance with the disclosed architecture; and

FIG. 6 illustrates a flowchart showing the method of displaying multiple vehicle stickers and cards on a vehicle windshield in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a vehicle sticker placard device that provides users with a convenient placard system for supporting vehicle identification stickers and cards. There is also a long-felt need in the art for a vehicle sticker placard device that allows users to place the placard on a windshield in a horizontal or vertical configuration via an adhesive, keeping the placard visible at all times. Further, there is a long-felt need in the art for a vehicle sticker placard device that includes multiple spaces to store inspection stickers, toll cards, parking cards or stickers, etc. Moreover, there is a long-felt need in the art for a device that eliminates the need to scrape the window with a blade to remove stickers if a windshield replacement is required. Further, there is a long-felt need in the art for a vehicle sticker placard device that is manufactured of plastic. Finally, there is a long-felt need in the art for a vehicle sticker placard device that allows users to insert and remove vehicle stickers and cards with case.

The present invention, in one exemplary embodiment, is a novel vehicle sticker placard device. The vehicle sticker placard device comprises a body component that is configured in a rectangular shape with several individual compartments to house city, state, toll, parking, and other stickers or identification cards. Each compartment is covered with a thin plastic sheet to create a pocket for displaying the cards or stickers. Each pocket comprises an open top, to allow users to easily interchange stickers/cards, as needed. The body component is removable and secures to a vehicle window with adhesive. Thus, users can place the device on their vehicle windshield and display appropriate stickers with ease. The present invention also includes a novel method of displaying multiple vehicle stickers and cards on a vehicle windshield. The method includes the steps of providing a vehicle sticker placard device comprising a body component with multiple pockets for displaying vehicle stickers and cards. The method also comprises inserting vehicle stickers and cards into the pockets to be displayed. Further, the method comprises securing the body component via adhesive to the interior of a vehicle windshield. Finally, the method comprises interchanging the vehicle stickers and cards, as needed.

Referring initially to the drawings, FIG. 1 illustrates a perspective view of one embodiment of the vehicle sticker placard device 100 of the present invention. In the present embodiment, the vehicle sticker placard device 100 is an improved vehicle sticker placard device 100 that provides a user with an expanded placard for a vehicle. Specifically, the vehicle sticker placard device 100 comprises a body component 102 that is configured in a rectangular shape with several individual compartments 104. Each compartment 104 is covered with a thin plastic sheet to create a pocket 106 for displaying the cards or stickers 108. The body component 102 is removable and secures to a vehicle window 110 with adhesive. Thus, users 112 can place the device 100 on their vehicle windshield 110 and display appropriate stickers and cards 108 with case.

Generally, the vehicle sticker placard device 100 contemplates a vehicle registration sticker, inspection sticker, certificate, license, parking sticker, and/or photograph display holder, etc., into which the stickers, certificates, licenses, cards, and/or photographs 108 may be inserted. Further, the vehicle sticker placard device 100 is used to removably display a number of different stickers, certificates, registration stickers, inspection stickers, parking stickers, certificates, licenses, and/or photographs, etc., 108, at one time.

Further, the vehicle sticker placard device 100 comprises a body component 102 of minimal thickness and an elongated rectangular configuration, with top and bottom elongated edges 114 extending generally parallel along the length thereof and with opposite end edges 116 extending transverse to the length thereof. The body component 102 also comprises a front surface 118 that faces out the vehicle windshield 110 and a rear surface 120 that faces the interior of the vehicle 122. Further, the body component 102 comprises a semi-rigid flat sheet of plastic material having multiple individual compartments 104 to display a registration sticker, inspection sticker, certificate, license, and/or photograph, etc., 108.

Additionally, the body component 102 comprises an adhesive coating layer 124 made of an impermanent adhesive material affixed to a front surface 118 of the body component 102, which allows the body component 102 to be repeatedly attached to one surface, removed, and attached to another surface without damaging the body component 102 or the surface to which the body component 102 is attached. The use of an impermanent adhesive allows the user 112 to use the body component 102 in multiple locations over a period of time. Further, because an impermanent adhesive will not damage the surface to which it is mounted, a user 112 is provided with significant flexibility as to the types of surfaces to which the body component 102 may be attached. Typically, the body component 102 is secured to an interior of the vehicle windshield 110.

Furthermore, the adhesive coating layer 124 is made of a flexible material, such that the body component 102 can be releasably secured to the interior of the vehicle window 110. The adhesive layer 124 may be approximately ⅛ inch thick and it is coated with a pressure sensitive adhesive. For packing and shipping, the adhesive layer 124 may be protected by a conventional peel-off covering 126. The peel-off covering 126 is peeled off and discarded to expose the adhesive layer 124, in order to adhere the device 100 to a supporting surface. Further, the adhesive coating layer 124 is an optically clear layer that is manufactured of transparent material to easily display the vehicle stickers and cards 108.

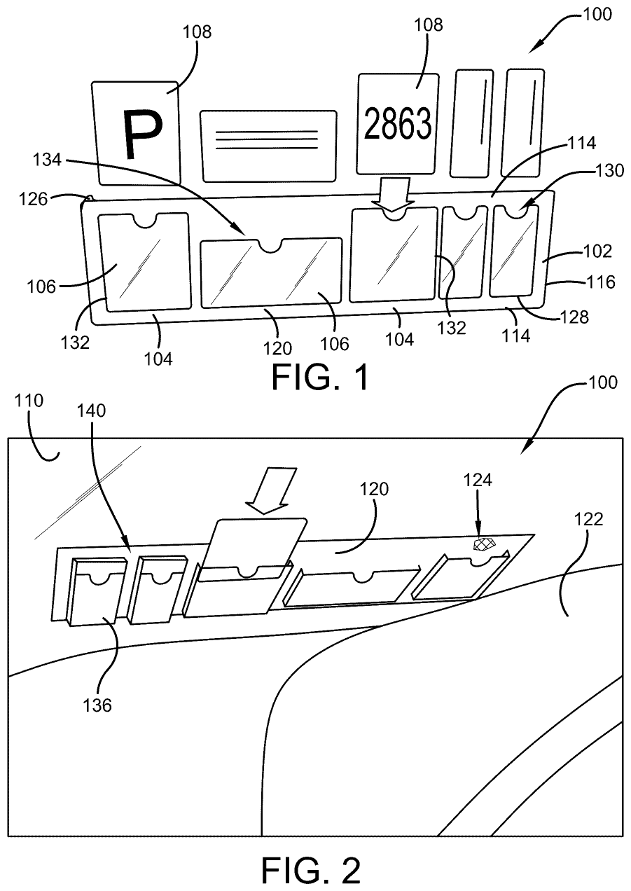

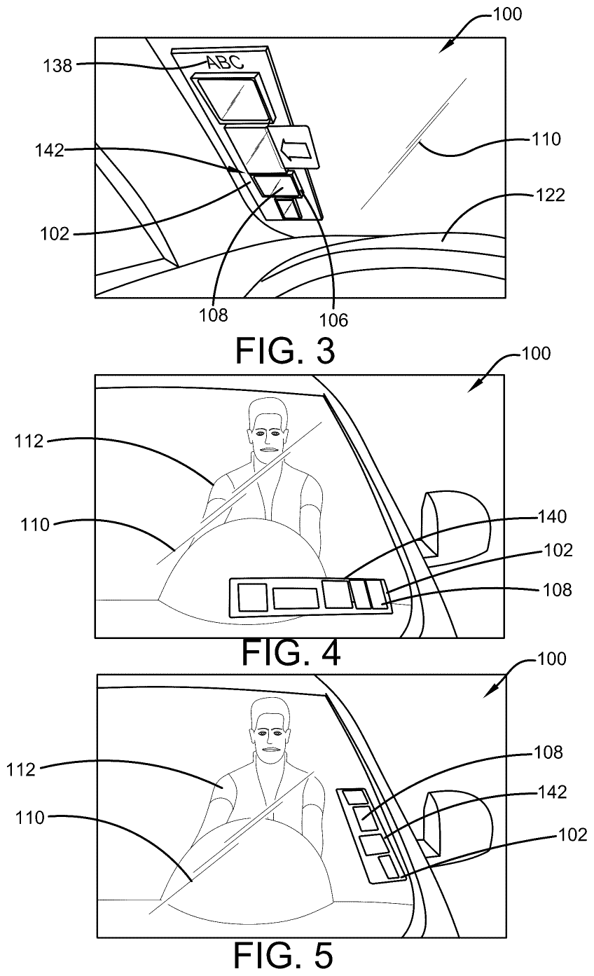

As shown in FIGS. 2-3, the body component 102 comprises a plurality of pockets 106 in which a removable vehicle registration card or sticker 108 is adapted to be slidably received and displayed. Specifically, the individual compartments 104 each comprise a pocket 106, and each of the pockets 106 act as a clear plastic protective sheath for displaying the vehicle cards/stickers 108. The pockets 106 allow the vehicle cards/stickers 108 to be prominently displayed on one side and seen through the vehicle window 110. Specifically, each compartment 104 is covered with a thin plastic sheet sealed at its perimeter edges 128, 132 and left open at the top 130, to create a pocket 106 for displaying the cards or stickers 108. Each pocket 106 comprises a sealed bottom seam 128, sealed opposing right and left seams 132, and an open top 130 creating an open interior 134. The open top 130 allows users 112 access to the open interior 134 and allows users 112 to easily interchange stickers/cards 108, as needed within the pockets 106. Further, the front surface 136 of the pockets 106 are optically clear for viewing the inserted vehicle stickers or cards 108 from one or both sides thereof.

Further, the body component 102 can comprise any suitable number of pockets 106. Further, the device 100 can be manufactured in different sizes, with a different number of pockets 106, depending on the needs and/or wants of a user 112. The pockets 106 can be any suitable size and shape as is known in the art, as long as they act to retain a vehicle sticker or card 108. Further, the body component 102 can comprise pockets 106 of varying size and width, depending on the needs and/or wants of a user 112.

In yet another embodiment, the vehicle sticker placard device 100 comprises a plurality of indicia 138. The body component 102 of the device 100 may include advertising, a trademark, or other letters, designs, or characters, printed, painted, stamped, or integrated into the body component 102, or any other indicia 138 as is known in the art. Specifically, any suitable indicia 138 as is known in the art can be included, such as, but not limited to, patterns, logos, emblems, images, symbols, designs, letters, words, characters, animals, advertisements, brands, etc., that may or may not be vehicle, vehicle stickers or cards, or brand related.

As shown in FIGS. 4-5, the body component 102 is made of a light plastic but durable material to protect the vehicle stickers and cards 108. Further, the body component 102 is manufactured of transparent material to easily display the vehicle stickers and cards 108. In one embodiment, the front 118 and rear 120 surfaces of the body component 102 are optically clear, thereby adapting the body component 102 for placement on the interior or exterior of a transparent window 110, such as the interior or exterior of a glass automobile window 110, for viewing the inserted vehicle stickers or cards 108 from one or both sides thereof. Preferably, for maximum adaptability, the compartments 104 and pockets 106, as well as the adhesive layer 124, are all manufactured of optically clear material. Further, the device 100 is transparent, so as not to interfere with a driver's view from the passenger compartment.

Further, the vehicle sticker placard device 100 can be configured in a horizontal 140 or vertical 142 configuration, depending on the needs and/or wants of a user 112. Specifically, the individual compartments 104 of the body component 102 can be arranged horizontally, in a linear line with the plurality of pockets 106 positioned side-by-side. In another embodiment, the individual compartments 104 of the body component 102 can be arranged vertically, such that the plurality of pockets 106 are positioned in a linear line with pockets 106 positioned above and below each other. Specifically, the plurality of pockets 106 are positioned, such that the bottom 128 of each pocket 106 contacts a top 130 of the pocket 106 below it. The horizontal 140 and vertical 142 configurations allow the users 112 to display the vehicles stickers and/or cards 108 within the body component 102 at particular locations on the interior of the vehicle windshield 110, as prescribed by the pertinent authorities, or issuers of the decals, stickers, or cards 108, as the case may be.

In use, the protective covering 126 is peeled off the adhesive coating layer 124, and the body component 102 is pressed against the inside face of the car windshield 110. By virtue of the flexibility in the body component 102 and the flexible adhesive coating layer 124, the body component 102 will readily accommodate itself to any curvature in the windshield 110. When the driver is in the vehicle 122, he/she will insert various vehicle registration cards and/or stickers 108, which he/she may carry in his/her wallet, into the pockets 106 of the body component 102 where they will be prominently displayed. Whenever the user 112 leaves the vehicle 122, he/she can remove the vehicle cards and/or stickers 108 and return them to his/her wallet, if needed, otherwise the vehicle cards and/or stickers 108 can remain in the pockets 106 of the body component 102 of the device 100.

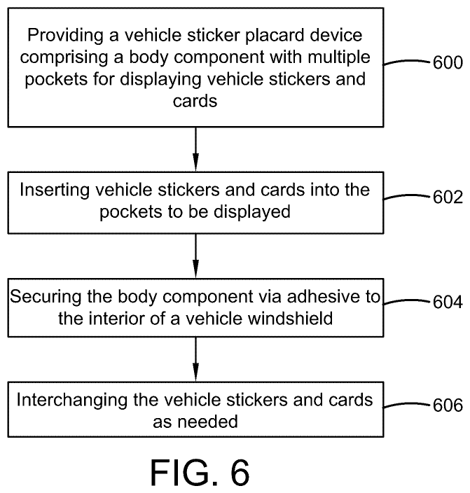

FIG. 6 illustrates a flowchart of the method of displaying multiple vehicle stickers and cards on a vehicle windshield. The method includes the steps of at 600, providing a vehicle sticker placard device comprising a body component with multiple pockets for displaying vehicle stickers and cards. The method also comprises at 602, inserting vehicle stickers and cards into the pockets to be displayed. Further, the method comprises at 604, securing the body component via adhesive to the interior of a vehicle windshield. Finally, the method comprises at 606, interchanging the vehicle stickers and cards, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “vehicle sticker placard device”, “vehicle sticker device”, “placard device”, and “device” are interchangeable and refer to the vehicle sticker placard device 100 of the present invention.

Notwithstanding the foregoing, the vehicle sticker placard device 100 of the present invention can be of any suitable size and configuration as is known in the art without affecting the overall concept of the invention, provided that it accomplishes the above-stated objectives. One of ordinary skill in the art will appreciate that the vehicle sticker placard device 100 as shown in FIGS. 1-6 is for illustrative purposes only, and that many other sizes and shapes of the vehicle sticker placard device 100 are well within the scope of the present disclosure. Although the dimensions of the vehicle sticker placard device 100 are important design parameters for user convenience, the vehicle sticker placard device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle sticker placard device that provides a user with an expanded placard for a vehicle, comprising:
a body component;
multiple individual compartments; and
a plurality of pockets; and
wherein the body component is configured in a rectangular shape with the multiple individual compartments;
wherein each of the multiple individual compartments are covered with a thin plastic sheet to create a pocket;
wherein the body component is secured to a vehicle windshield; and
wherein the plurality of pockets display vehicle stickers and cards.

2. The vehicle sticker placard device of claim 1 wherein the vehicle stickers and cards comprise at least one of a vehicle registration sticker, an inspection sticker, a certificate, a license, a parking sticker, or a photograph display holder.

3. The vehicle sticker placard device of claim 2 wherein the body component is of minimal thickness and an elongated rectangular configuration, with top and bottom elongated edges extending generally parallel along a length thereof and with opposite end edges extending transverse to the length thereof.

4. The vehicle sticker placard device of claim 3 wherein the body component comprises a front surface that faces out the vehicle windshield and a rear surface that faces an interior of a vehicle.

5. The vehicle sticker placard device of claim 4 wherein the body component comprises an adhesive coating layer made of an impermanent adhesive material affixed to the front surface of the body component, which allows the body component to be repeatedly attached to one surface, removed, and attached to another surface without damaging the body component or the surfaces to which the body component is attached.

6. The vehicle sticker placard device of claim 5 wherein the adhesive coating layer is protected by a peel-off covering.

7. The vehicle sticker placard device of claim 6 wherein the adhesive coating layer is an optically clear layer that is manufactured of transparent material.

8. The vehicle sticker placard device of claim 7 wherein each of the plurality of pockets comprise a thin plastic sheet with a sealed bottom seam, sealed opposing right and left seams, and an open top creating an open interior.

9. The vehicle sticker placard device of claim 8 wherein the open top allows users access to the open interior and allows users to easily interchange vehicle stickers and cards, as needed within the plurality of pockets.

10. The vehicle sticker placard device of claim 9 wherein a front surface of the plurality of pockets are optically clear for viewing inserted vehicle stickers or cards from one or both sides thereof.

11. The vehicle sticker placard device of claim 10 wherein the body component is configured in a vertical configuration.

12. The vehicle sticker placard device of claim 10 wherein the body component is configured in a horizontal configuration.

13. A vehicle sticker placard device that provides a user with an expanded placard for a vehicle, comprising:
a body component of minimal thickness and an elongated rectangular configuration, with top and bottom elongated edges extending generally parallel along a length thereof and with opposite end edges extending transverse to the length thereof;
multiple individual compartments; and
a plurality of pockets which each comprise a thin plastic sheet with a sealed bottom seam, sealed opposing right and left seams, and an open top creating an open interior; and
wherein the body component comprises a front surface that faces out the vehicle windshield and a rear surface that faces an interior of a vehicle;
wherein the body component comprises an adhesive coating layer made of an impermanent adhesive material affixed to the front surface of the body component, which allows the body component to be repeatedly attached to one surface, removed, and attached to another surface without damaging the body component or the surfaces to which the body component is attached;
wherein the adhesive coating layer is protected by a peel-off covering;
wherein each of the multiple individual compartments are covered with a thin plastic sheet to create a pocket;
wherein the open top allows users access to the open interior and allows users to easily interchange vehicle stickers and cards, as needed within the plurality of pockets; and
wherein the body component is removably secured to a vehicle windshield.

14. The vehicle sticker placard device of claim 13 wherein the body component comprises a plurality of pockets of different sizes and widths.

15. The vehicle sticker placard device of claim 13 wherein the body component comprises a varying number of pockets.

16. The vehicle sticker placard device of claim 13 further comprising a plurality of indicia.

17. The vehicle sticker placard device of claim 13 wherein the body component is manufactured of a transparent material to easily display the vehicle stickers and cards.

18. The vehicle sticker placard device of claim 13 wherein the multiple individual compartments and the plurality of pockets, as well as the adhesive coating layer, are all manufactured of optically clear material.

19. The vehicle sticker placard device of claim 13 wherein the body component is configured in a vertical or horizontal configuration.

20. A method of displaying multiple vehicle stickers and cards on a vehicle windshield, comprising the following steps:
providing a vehicle sticker placard device comprising a body component with multiple pockets for displaying vehicle stickers and cards;
inserting vehicle stickers and cards into the pockets to be displayed;
securing the body component via adhesive to the interior of a vehicle windshield; and
interchanging the vehicle stickers and cards, as needed.
